(19) United States
(12) Patent Application Publication
(10) Pub. No.: US 2021/0029720 A1
(43) Pub. Date: Jan. 28, 2021

(54) RADIO NETWORK NODE, WIRELESS DEVICE AND METHODS PERFORMED THEREIN FOR TRANSMITTING DATA ON PRIORITIZED LOGICAL CHANNELS

(71) Applicant: Telefonaktiebolaget LM Ericsson (publ), Stockholm (SE)

(72) Inventors: Min WANG, LULEÅ (SE); Jonas FRÖBERG OLSSON, LJUNGSBRO (SE); Henrik ENBUSKE, STOCKHOLM (SE); Mats FOLKE, VÄLLINGBY (SE); Jinhua LIU, BEIJING (CN)

(21) Appl. No.: 16/982,649

(22) PCT Filed: Jun. 20, 2019
(86) PCT No.: PCT/SE2019/050597

§ 371 Date: Sep. 21, 2020

(30) Foreign Application Priority Data
Jun. 21, 2018 (CN) PCT/CN2018/092149

(51) Int. Cl. H04W 72/10; H04W 72/12; H04W 72/14; H04W 52/08

(52) U.S. Cl. CPC H04W 72/10; H04W 52/08; H04W 72/14; H04W 72/1268

(57) ABSTRACT

A Logical Channel Prioritization (LCP) procedure enables a wireless device to apply an LCP mapping restriction including at least one out of: a transmission reliability requirement, a power control requirement, and information specifying whether a service's logical channel is allowed to use an uplink grant associated with a different service.

### TECHNICAL FIELD

Embodiments herein relate to a radio network node, a wireless device and methods performed therein for communication. Furthermore, a computer program product and a computer readable storage medium are also provided herein. In particular, embodiments herein relate to transmission of data on prioritized logical channels.

### BACKGROUND

In a typical wireless communication network, wireless devices, also known as wireless communication devices, mobile stations, stations (STAs) and/or user equipments (UEs), communicate via a Radio Access Network (RAN) to one or more core networks (CNs). The RAN covers a geographical area which is divided into service areas or cells, with each service area or cell being served by a radio network node such as a radio access node e.g., a Wi-Fi access point or a Radio Base Station (RBS), which in some networks may also be denoted, for example, a “NodeB” (NB) or “eNodeB” (eNB), “gNodeB” (gNB). A service area or cell is a geographical area where radio coverage is provided by the radio network node. The radio network node communicates over an air interface operating on radio frequencies with the wireless device within range of the radio network node.

A Universal Mobile Telecommunications System (UMTS) is a third generation (3G) telecommunication network, which evolved from the second generation (2G) Global System for Mobile Communications (GSM). The UMTS Terrestrial Radio Access Network (UTRAN) is essentially a RAN using Wideband Code Division Multiple Access (WCDMA) and/or High Speed Packet Access (HSPA) for wireless devices. In a forum known as the Third Generation Partnership Project (3GPP), telecommunications suppliers propose and agree upon standards for third generation networks, and investigate enhanced data rate and radio capacity. In some RANs, e.g. as in UMTS, several radio network nodes may be connected, e.g., by landlines or microwave, to a controller node, such as a Radio Network

Controller (RNC) or a Base Station Controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS), also called a Fourth Generation (4G) network, have been completed within the 3^{rd} Generation Partnership Project (3GPP) and this work continues in the coming 3GPP releases, for example to specify a Fifth Generation (5G) network. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface. EPS is the Evolved 3GPP Packet Switched Domain. New Radio (NR) is a new radio access technology being standardized in 3GPP.

The Medium Access Control (MAC) layer of a NR communications network provides services to the Radio Link Control (RLC) layer in the form of logical channels. A logical channel is defined by the type of information it carries and is generally differentiated as a control channel used for transmission of control and configuration information or as a traffic channel used for transmission of user data. Logical Channel Prioritization (LCP) is designed to ensure that a UE satisfies required Quality of Service (QoS) of each configured radio bearer. For every received uplink grant indicating a new transmission, the UE may decide on the amount of data for each logical channel to be included in a new Medium Access Control (MAC) Protocol Data Unit (PDU), and, if necessary, also to allocate space for a MAC Control Element (CE).

In the existing NR MAC specification, e.g. 3GPP 38.321-f10, an LCP procedure is applied by a UE whenever a new uplink transmission is performed. A logical channel (LCH) is used to provide services for the MAC layer within the radio protocol structure.

### The LCP Procedure

Scheduling of uplink data may be controlled, e.g., via Radio Resource Control (RRC) for each logical channel per MAC entity, by signalling:
priority where an increasing priority value indicates a lower priority level;
prioritisedBitRate which sets the Prioritized Bit Rate (PBR);
bucketSizeDuration which sets the Bucket Size Duration (BSD).

The MAC entity is the entity that performs the MAC layer functionalities.

Additionally the LCP procedure may be controlled, e.g., via RRC signalling, by configuring an LCP mapping restriction for each logical channel, such as:
allowedSCS-List which sets the allowed Subcarrier Spacing(s) (SCS) for transmission;
maxPUSCH-Duration which sets the maximum Physical Uplink Shared CHannel (PUSCH) duration allowed for transmission;
configuredGrantType1Allowed which sets whether a configured grant Type 1 can be used for transmission;
allowedServingCells which sets the allowed cell(s) for transmission.

The following UE variable Bj may be used for the LCP procedure:
Bj which is maintained for each logical channel j.
Bj is a variable that represents the current bucket contents for the logical channel j.

The MAC entity may initialize Bj of the logical channel to zero when the logical channel (LCH) is established.

For each logical channel j, the MAC entity may:
1>increment Bj by the product PBR×T before every instance of the LCP procedure, where T is the time elapsed since Bj was last incremented;
1>if the value of Bj is greater than the bucket size (i.e. PBR×BSD):
   2>set Bj to the bucket size.

The exact moment(s) when the UE updates Bj between LCP procedures is up to UE implementation, as long as Bj is up to date at the time when a grant is processed by LCP.

### Selection of Logical Channels

A MAC entity of the UE may, when a new transmission is performed:
1>select the logical channels for each UL grant that satisfy all the following conditions:
   2>the set of allowed Subcarrier Spacing (SCS) index values in allowedSCS-List, if configured, includes the Subcarrier Spacing index associated to the UL grant; and
   2>maxPUSCH-Duration, if configured, is larger than or equal to the PUSCH transmission duration associated to the UL grant; and
   2>configuredGrantType1Allowed, if configured, is set to TRUE in case the UL grant is a Configured Grant Type 1; and
   2>allowedServingCells, if configured, includes the Cell information associated to the UL grant.

The Subcarrier Spacing index, the PUSCH transmission duration and the Cell information may be included in an Uplink transmission information received in the MAC layer from lower layers for the corresponding scheduled uplink transmission. For example, the MAC layer may receive the Uplink transmission information from a physical layer.

### Allocation of Resources

The MAC entity of the UE may, when a new transmission is performed:
1>allocate resources to the logical channels as follows:
   2>the selected logical channels for the UL grant with Bj>0 are allocated resources in a decreasing priority order. As mentioned above, the priority is signalled and an increasing priority value indicates a lower priority level. Thus, uplink data having a low priority value will be allocated resources before uplink data having a high priority value. In other words, the uplink data having the lowest priority value has the highest priority level and will be allocated resources first. If the PBR of a logical channel is set to “infinity”, the MAC entity may allocate resources for all the data that is available for transmission on the logical channel before meeting the PBR of the lower priority logical channel(s);
   2>decrement Bj by the total size of a MAC Service Data Unit(-s) (SDU) served to logical channel j above;
   2>if any resources remain, all the selected logical channels are served in a strict decreasing priority order, regardless of the value of Bj, until either the data for that logical channel or the UL grant is exhausted, whichever comes first. Logical channels configured with equal priority should be served equally.

The value of Bj may be negative.

The above LCP procedure may be performed in terms of the priority of the LCH and the PUSCH transmission duration which is associated with the UL grant.

Relevant RAN1 agreements on the new Ultra-Reliable and Low Latency Communications (URLLC) Modulation Coding Scheme (MCS) table will now be described.

At 3GPP RAN1#93, RAN2 has made some agreements concerning a new MCS table due to the fact the existing MCS tables are insufficient for users such as UEs at a cell edge. These agreements will be highlighted herein as below:

Agreements:
For the URLLC, for grant-based transmissions, introduce one RRC parameter for configuring a new Radio Network Temporary Identifier (RNTI).
   When the new RNTI is not configured, existing RRC parameter mcs-table is extended to select from 3 MCS tables, e.g. from the existing 64 Quadrature Amplitude Modulation (QAM) MCS table, the existing 256QAM MCS table, and from a new 64QAM MCS table.
      When mcs-table indicates the new 64QAM MCS table:
         For Downlink Control Information (DCI) format 0_0/1_ 0 in Common Search Space (CSS), existing 64QAM MCS table is used.
         For DCI formats 0_ 0/1_0/0_1/1_1 in UE-specific Search Space (USS), new 64QAM MCS table is used.
      Otherwise, follow existing behavior.
      Note: the configuration for downlink (DL) and uplink (UL) is separate.
   When the new RNTI (via RRC) is configured, an RNTI scrambling of DCI Cyclic Redundancy Check (CRC) is used to choose MCS table:
      If the DCI CRC is scrambled with the new RNTI, the new 64QAM MCS table is used; otherwise, follow existing behavior.

Agreements:

For both initial transmission and re-transmissions for Grant Free (GF) scheduling for the URLLC,
For an UL configured grant, the MCS table is configured by the existing parameter associated with the RRC configured grant configuration, which is extended to include the new 64QAM MCS table.
For a DL Semi-Persistent Scheduling (SPS), the RRC indicates whether or not the new 64QAM table is configured. The indication for the new MCS table for the DL SPS is separate from the one for grant-based DL scheduling.

From the above agreements, it is observed that:
1) For a dynamic scheduling, the new MCS table may be configured and/or indicated via the RRC signalling or the DCI. For the latter case, an additional RNTI is defined.
2) For a grant free (GF) transmission, the new MCS table is configured via the RRC signalling.

### SUMMARY

An object of embodiments herein is to provide a mechanism for improving performance of the wireless communication network in an efficient manner.

According to an aspect the object is achieved by providing a method performed by a wireless device for transmitting data on prioritized logical channels. The wireless device receives a Logical Channel Prioritization, LCP, mapping restriction from a radio network node.

The wireless device selects logical channels (LCHs) for an uplink (UL) grant that satisfy the LCP mapping restriction. The LCP mapping restriction comprises at least one out of: a transmission reliability requirement, a power control requirement, and information specifying whether a service's LCH is allowed to use the UL grant associated with a different service.

The wireless device allocates resources to the selected LCHs according to priorities of the selected LCHs.

The wireless device transmits data using the allocated resources.

According to another aspect the object is achieved by providing a method performed by a radio network node for facilitating a wireless device in transmitting data on prioritized logical channels.

The radio network node sends a Logical Channel Prioritization, LCP, mapping restriction to the wireless device for facilitating the wireless device selecting logical channels (LCHs) for an uplink (UL) grant. The LCP mapping restriction comprises at least one out of: a transmission reliability requirement, a power control requirement, and information specifying whether a service's LCH is allowed to use the UL grant associated with a different service.

According to still another aspect the object is achieved by providing a wireless device for transmitting data on prioritized logical channels. The wireless device is configured to perform one or more out of: receive a Logical Channel Prioritization, LCP, mapping restriction from a radio network node; select logical channels (LCHs) for an uplink (UL) grant that satisfy the LCP mapping restriction; allocate resources to the selected LCHs according to priorities of the selected LCHs; and transmit data using the allocated resources. The LCP mapping restriction comprises at least one out of: a transmission reliability requirement, a power control requirement, and information specifying whether a service's LCH is allowed to use the UL grant associated with a different service.

According to yet another aspect the object is achieved by providing a radio network node for facilitating a wireless device in transmitting data on prioritized logical channels. The radio network node is configured to send a Logical Channel Prioritization, LCP, mapping restriction to the wireless device for facilitating the wireless device selecting logical channels (LCHs) for an uplink (UL) grant, wherein the LCP mapping restriction comprises at least one out of: a transmission reliability requirement, a power 25 control requirement, and information specifying whether a service's LCH is allowed to use the UL grant associated with a different service.

It is furthermore provided herein a computer program product comprising instructions, which, when executed on at least one processor, cause the at least one processor to carry out any of the methods above, as performed by the wireless device or the radio network node. It is additionally provided herein a computer-readable storage medium, having stored thereon a computer program product comprising instructions which, when executed on at least one processor, cause the at least one processor to carry out the method according to any of the methods above, as performed by the wireless device or the radio network node.

According to still another aspect the object is achieved by providing a wireless device comprising processing circuitry configured to one or more out of: receive a LCP mapping restriction from a radio network node; select logical channels (LCHs) for an uplink (UL) grant that satisfy the LCP mapping restriction; allocate resources to the selected LCHs according to priorities of the selected LCHs; and transmit data using the allocated resources. The LCP mapping restriction comprises at least one out of: a transmission reliability requirement, a power control requirement, and information specifying whether a service's LCH is allowed to use the UL grant associated with a different service.

According to still another aspect the object is achieved by providing a radio network node comprising processing circuitry configured to send a LCP mapping restriction to the wireless device for facilitating the wireless device selecting logical channels (LCHs) for an uplink (UL) grant, wherein the LCP mapping restriction comprises at least one of: a transmission reliability requirement, a power control requirement, and information specifying whether a service's LCH is allowed to use the UL grant associated with a different service.

Embodiments herein provide an improved LCP procedure by enabling the wireless device to apply the above newly introduced LCP mapping restriction. By employing the mechanisms described here, several advantages may be achieved. For instance, the transmission reliability for a service will be better enforced. Negative impact of a service on another service may be avoided. Furthermore, a better quality of service differentiation may be achieved.

### BRIEF DESCRIPTION OF THE DRAWINGS

Embodiments will now be described in more detail in relation to the enclosed drawings, in which:

FIG. 1 is a schematic overview depicting a wireless communication network according to embodiments herein;

FIG. 2 is a flowchart depicting a method performed by a wireless device according to embodiments herein;

FIG. 3 is a flowchart depicting a method performed by a radio network node according to embodiments herein;

FIG. 4 is a combined signalling scheme and flowchart according to embodiments herein;

FIG. 5 is a block diagram depicting a wireless device according to embodiments herein;

FIG. 6 is a block diagram depicting a radio network node according to embodiments herein; and

FIG. 7-FIG. 12 are flowcharts illustrating methods implemented in a communication system including a host computer, a base station and a user equipment.

### DETAILED DESCRIPTION

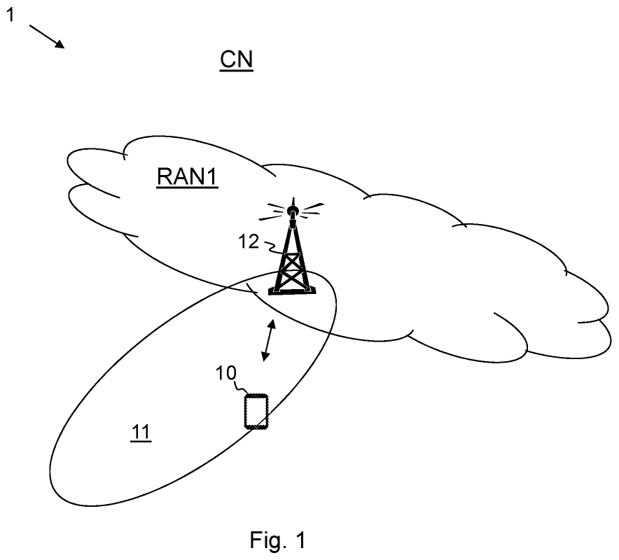

Embodiments herein relate to wireless communication networks in general. FIG. 1 is a schematic overview depicting a wireless communication network 1. The wireless communication network 1 comprises one or more RANs e.g. a first RAN (RAN1), connected to one or more CNs. The wireless communication network 1 may use one or more technologies, such as Long Term Evolution (LTE), LTE-Advanced, 5G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are applicable also in further development of the existing communication systems such as e.g. 3G and LTE.

In the wireless communication network 1, wireless devices e.g. a wireless device such as a mobile station, a non-access point (non-AP) station (STA), a STA, a user equipment and/or a wireless terminal, are connected via the one or more RANs, to the one or more CNs. It should be understood by those skilled in the art that “wireless device” is a non-limiting term which means any terminal, wireless communication terminal, communication equipment, Machine Type Communication (MTC) device, Device to Device (D2D) terminal, or user equipment e.g. smart phone, laptop, mobile phone, sensor, relay, mobile tablets or any device communicating within a cell or service area. The wireless device searches for carriers using a carrier raster. The carrier raster indicating possible frequency positions of a carrier for the wireless device.

The wireless communication network 1 comprises a radio network node 12. The radio network node 12 is exemplified herein as a RAN node providing radio coverage over a geographical area, a first service area 11, of a Radio Access Technology (RAT), such as NR, LTE, UMTS, Wi-Fi or similar. The radio network node 12 may be a radio access network node such as radio network controller or an access point such as a Wireless Local Area Network (WLAN) access point or an Access Point Station (AP STA), an access controller, a base station, e.g. a radio base station such as a NodeB, a gNodeB, an evolved Node B (eNB, eNodeB), a base transceiver station, Access Point Base Station, base station router, a transmission arrangement of a radio base station, a stand-alone access point or any other network unit capable of serving a wireless device 10 within the service area served by the radio network node 12 depending e.g. on the radio access technology and terminology used and may be denoted as a receiving radio network node. The radio network node 12 may alternatively be a core network node such as an MME or controlling network node.

It should be noted that a service area may be denoted as cell, beam, beam group or similar to define an area of radio coverage.

In the existing LCP procedure, the parameters, e.g., allowedSCS-List and maxPUSCH-Duration, may be used to control the logical channels to do multiplexing in terms of the numerology and the PUSCH transmission duration. Typically, the multiplexing allows the data from different services, e.g., enhanced Mobile Broadband (eMBB) and URLLC services, to be transmitted in the same MAC PDU so that the resource may be utilized efficiently and so that an eMBB data with long transmission latency requirement may be avoided to use an URLLC grant associated with a short PUSCH transmission duration. Similarly, the URLLC data would not use an eMBB grant associated with a long duration.

However, the existing LCP mapping restrictions do not take transmission reliability (which indicates how robust the transmission is) into consideration. For example, a URLLC traffic may require two categories of transmission reliability requirements, such as a block error rate (BLER) target 10⁻⁵ and a BLER target 10⁻¹. The 3GPP has defined a new MCS table for a need of BLER target 10⁻⁵ when users such as wireless devices are at a cell edge. However the existing MCS tables are still insufficient to fulfil the transmission reliability requirements.

Considering the above situation, in some cases, the eMBB data with the BLER target 10⁻¹ is not allowed to multiplex with the URLLC data with the BLER target 10⁻⁵ since the grant is associated with the BLER target 10⁻⁵. Similarly, in some other cases, the URLLC requiring the BLER 10⁻⁵ is not allowed to do multiplexing with the eMBB data for the grant which is associated with the BLER target 10⁻¹.

Therefore, the existing LCP procedure will be enhanced herein to consider the transmission reliability. The enhancement will consider the recent 3GPP agreements.

Embodiments herein enhance the existing LCP procedure to consider one or more of restrictions, such as transmission reliability requirement and a power control requirement so that the logical channels and/or service with different requirements are not to be multiplexed together to use the same uplink resource. In this way, the service, e.g., the URLLC service, requiring extremely high reliability and special power boosting may be transmitted alone to better achieve a desired performance target. Different services, e.g., URLLC and eMBB services, will not interrupt each other.

By employing the mechanisms described herein, the transmission reliability for a service, e.g., the URLLC service, will be better enforced, due to the newly introduced restriction on the transmission reliability requirement and/or power control requirement. Negative impact of a service, e.g., of an eMBB service on another service, e.g., an URLLC service, may be avoided, thanks to the information specifying whether a service's LCH is allowed to use the UL grant associated with a different service. Furthermore, a better quality of service differentiation will be achieved.

The terms LCP mapping restriction, LCP restriction, restriction, and metric are interchangeable herein in this disclosure. Meanwhile the term PHY layer, MAC layer may also be referred to as PHY entity, MAC entity, respectively.

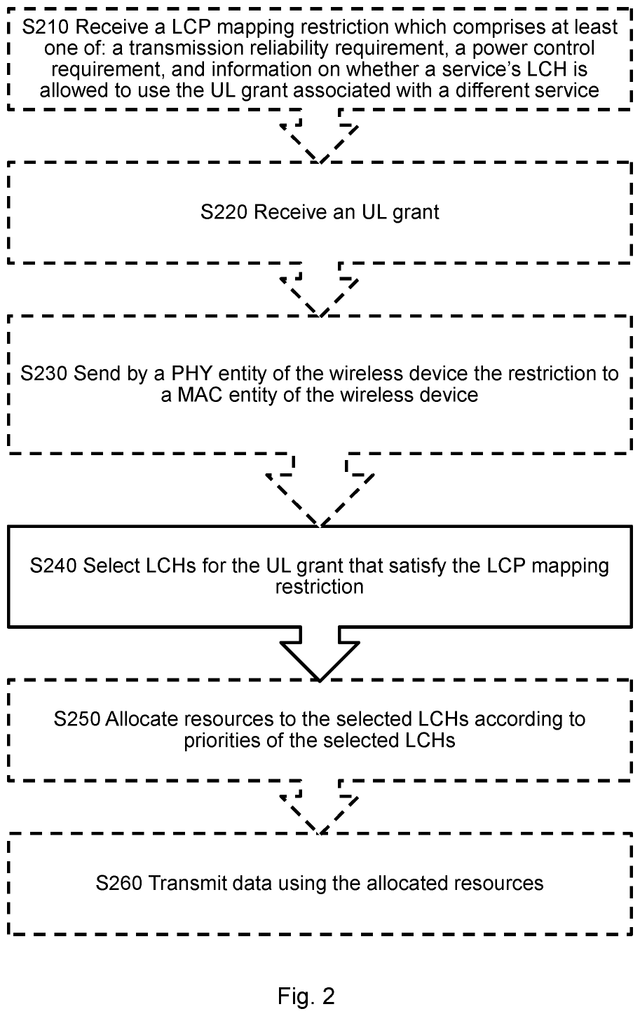

The method actions performed by the wireless device 10 for performing logical channel prioritization according to embodiments herein will now be described with reference to a flowchart depicted in FIG. 2, together with FIG. 4 which is a schematic combined signaling scheme and flowchart depicting embodiments herein. The method actions performed by the wireless device 10 may also be referred to as method actions performed by the wireless device 10 for transmitting data on prioritized logical channels. The actions do not have to be taken in the order stated below, but may be taken in any suitable order. Actions performed in some embodiments may be marked with dashed boxes.

Action S210. In order to perform the LCP, the wireless device 10 may receive, e.g., by a receiving module of the wireless device 10, an LCP mapping restriction from a radio network node 10, e.g., via a RRC signalling.

Action S220. The wireless device 10 may further receive, e.g., by a receiving module of the wireless device 10, an UL grant. This may be received in response to a request for resource to be used for data to be transmitted.

Action S230. Within the wireless device 10, e.g., a physical (PHY) entity of the wireless device 10 may send the LCP mapping restriction to a MAC entity of the wireless device 10. Therefore the MAC entity of the wireless device 10 can perform the LCP based on the received LCP mapping restriction. This will be described more below, e.g. in Action S240.

Action S240. The wireless device 10 may select logical channels for the UL grant that satisfy the LCP mapping restriction. In other words, the wireless device 10, e.g. by means of the MAC entity, may select logical channels for the UL grant that satisfy the LCP mapping restriction. Thereby, the wireless device 10 may prioritize logical channels for the UL grant that satisfy the LCP mapping restriction. Thus, the wireless device 10, e.g. by means of the MAC entity, may perform the LCP based on the received LCP mapping restriction.

The LCP mapping restriction comprises at least one out of: a transmission reliability requirement, a power control requirement, and information specifying whether a service's LCH is allowed to use the UL grant associated with a different service.

The transmission reliability requirement may specify a maximum block error rate, which is also referred to as BLER target in the disclosure.

For example, the MAC entity may perform the LCP based on the received LCP mapping restriction by prioritizing logical channels that have a high transmission reliability, and/or requirement on higher transmission power, and/or whether or not a logical channel or service is also allowed to use a UL grant associated with another logical channel or service.

Uplink Power Control (UPC) may comprise alpha based power control and closed loop power control. The Closed loop power control is the ability of the wireless device 10 to adjust the uplink transmit power in accordance with closed-loop correction values: A closed-loop correction value may be carried by a Transmit Power Control (TPC) command transmitted on a Physical Downlink Control Channel (PDCCH).

The power control requirement may specify at least one out of: a set of allowed P0-PUSCH-AlphaSet for transmission, and a set of allowed PUSCH closed loop index.

The LCP mapping restriction may further specify at least one out of: an allowed Subcarrier Spacing for transmission, a maximum Physical Uplink Shared Channel (PUSCH) duration allowed for transmission, information on whether a configured grant Type 1 may be used for transmission, and an allowed cell for transmission.

Action S250. The wireless device 10 may allocate, e.g. by the MAC entity, resources to the selected LCHs according to the priorities of the selected LCHs. For instance, the resources may be allocated in a decreasing priority order.

Action S260. The wireless device 10 may then transmit, e.g., by the MAC entity, uplink data using the allocated resources, e.g., to the radio network node 12.

By employing the mechanisms described herein, the transmission reliability for a service, e.g., the URLLC service, will be better enforced, due to the newly introduced restriction on the transmission reliability requirement and/or power control requirement. Negative impact of a service, e.g., of the eMBB service on another service, e.g., the URLLC service, may be avoided, thanks to the information specifying whether a service's LCH is allowed to use the UL grant associated with a different service. Furthermore, a better quality of service differentiation will be achieved.

In the following, various embodiments are described in the context of NR, however the skilled person will appreciate that the embodiments herein are also applied to other wireless communication system.

Three different restrictions are introduced in the following embodiments. These three restrictions may be applied separately, or in any combination thereof.

In an example embodiment, an additional LCP mapping restriction for transmission reliability, i.e., a transmission reliability requirement, is defined for each

LCH. For example, this new LCP restriction for transmission reliability may be named as maximumPUSCH-BLER, which defines a maximum PUSCH BLER target allowed for transmission. The MAC entity of the wireless device 10 may check the existing LCP restrictions plus the new defined LCP restriction for transmission reliability, when a new transmission is performed, by e.g.:
1>select the logical channels for each UL grant that satisfy all the following conditions:
2>the set of allowed Subcarrier Spacing index values in allowedSCS-List, if configured, includes the Subcarrier Spacing index associated to the UL grant; and
2>maxPUSCH-Duration, if configured, is larger than or equal to the PUSCH transmission duration associated to the UL grant; and
2>configuredGrantType1Allowed, if configured, is set to TRUE in case the UL grant is a Configured Grant Type 1; and
2>allowedServingCells, if configured, includes the Cell information associated to the UL grant; and
2>maxPUSCH-BLER, if configured, is lower or equal to the PUSCH transmission BLER target associated to the UL grant.

The PUSCH transmission BLER may be included in Uplink transmission information received from lower layers for the corresponding scheduled uplink transmission. The PUSCH transmission BLER may be learned by the physical (PHY) layer upon reception of a DCI indicating an uplink grant.

There may be several options for the radio network node 12, e.g., a gNB, to send and/or indicate the PUSCH transmission reliability requirement. In a first option, the PUSCH transmission BLER is indicated via a RNTI associated to the uplink grant. For example, the PUSCH transmission BLER may be indicated using the newly defined RNTI by 3GPP for the new MCS table for URLLC. In a second option, the radio network node 12, e.g., a gNB, may send and/or indicate the PUSCH transmission reliability requirement via a MCS table associated to the uplink grant. For example, the PUSCH transmission reliability requirement may be indicated using the newly defined MCS table by 3GPP for the URLLC. In a third option, the DCI format may be updated to carry an indication on the PUSCH transmission reliability requirement, e.g., BLER, explicitly. In a fourth option, the DCI may be associated with a specific search space to indicate the PUSCH transmission reliability requirement, e.g., the BLER. In a fifth option, a new MAC-CE may be defined to signal the MCS table and/or the PUSCH transmission reliability requirement, e.g., the BLER, for upcoming PUSCH transmissions.

Embodiments herein taking BLER as an example of the transmission reliability, however the skilled person will appreciate that embodiments herein are equally applicable to any manner specifying the transmission reliability.

In another embodiment, an additional LCP mapping restriction for power control, i.e., a power control requirement, is defined for each LCH. For example, this new LCP mapping restriction for power control may be a P0-PUSCH-AlphaSetId-List, and/or a PUSCH-closed-loop-index-List.

The LCP mapping restriction for power control may define a power control process and/or a configuration allowed for transmission. The MAC entity may check the existing LCP restrictions plus the new defined LCP restriction for power control, when a new transmission is performed, e.g. by:
1>select the logical channels for each UL grant that satisfy all the following conditions:
   2>the set of allowed Subcarrier Spacing index values in allowedSCS-List, if configured, includes the Subcarrier Spacing index associated to the UL grant; and
   2>maxPUSCH-Duration, if configured, is larger than or equal to the PUSCH transmission duration associated to the UL grant; and 2>configuredGrantType1Allowed, if configured, is set to TRUE in case the UL grant is a Configured Grant Type 1; and
   2>allowedServingCells, if configured, includes the Cell information associated to the UL grant; and
   2>a set of allowed P0-PUSCH-AlphaSet values in P0-PUSCH-AlphaSetId-List or the set of allowed PUSCH closed loop index values in PUSCH-closed-loop-index-List, if configured, includes the P0-PUSCH-AlphaSetId or PUSCH closed loop index associated to the UL grant.

The new LCP restriction for power control is added to avoid multiplexing LCHs with different power control requirements together. For example, the URLLC may require power boosting for higher transmission reliability. In this case, the URLLC may not be multiplexed with the eMBB data for a grant associated with the URLLC service. The above options for indicating the PUSCH transmission duration are also applicable here for the gNB to indicate the power control loop and/or the power control configuration to the 30 UE such as the wireless device 10.

In another embodiment, an additional LCP mapping restriction, i.e., information specifying whether a service's LCH is allowed to use the UL grant associated with a different service, is defined for each LCH. The PHY layer of the wireless device 10 may send an additional indicator indicating the above information, e.g., whether an eMBB service is allowed to use the grant, if the grant is associated with a URLLC service. The indicator may also indicate information whether the URLLC service is allowed to use the grant if the grant is associated with the eMBB service. The MAC entity performs the LCP procedures for each LCH considering the additional indicator provided by the PHY layer.

In the above embodiments, the PHY layer may provide relevant information and/or signalling for the LCP to the MAC entity. With respect to the transmission reliability embodiment, the PHY layer may provide information on the transmission reliability, such as the BLER target, which is associated with the current UL grant. With respect to the power control embodiment, the PHY layer may provide the power control process and/or power control loop and/or power control configuration that is associated with the current UL grant. In another embodiment, the PHY layer may provide an indicator whether other LCHs of a service are allowed to multiplex and/or use on the uplink grant associated to another service, together with the LCHs that are intended to use the uplink grant.

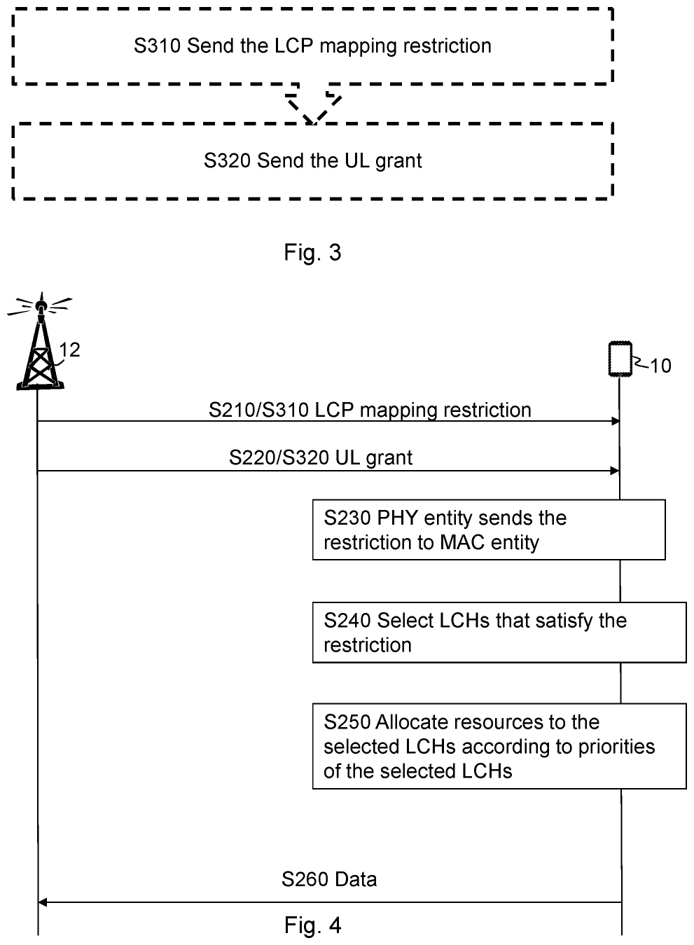

The method actions performed by the radio network node 12 for facilitating a wireless device 10 performing logical channel prioritization according to embodiments herein will now be described with reference to a flowchart depicted in FIG. 3, in together with FIG. 4. The method actions performed by the radio network node 12 may also be referred to as method actions performed by radio network node 12 for facilitating a wireless device 10 in transmitting data on prioritized logical channels. The actions do not have to be taken in the order stated below, but may be taken in any suitable order. Actions performed in some embodiments may be marked with dashed boxes.

Action S310. The radio network node 12 may send, e.g., via a RRC signalling, the above LCP mapping restriction to the wireless device 10, for facilitating the wireless device 10 to select the LCHs for the UL grant. As previously mentioned, the LCP mapping restriction comprises at least one out of: a transmission reliability requirement, a power control requirement, and information specifying whether a service's LCH is allowed to use the UL grant associated with a different service.

As also previously mentioned, the transmission reliability requirement may specify a maximum block error rate. Further, and as also previously mentioned, the power control requirement may specify at least one out of: a set of allowed P0-PUSCH-AlphaSet for transmission, and a set of allowed PUSCH closed loop index.

Action S320. The radio network node 12 may also send the UL grant, e.g., the UL grant associated to a service, to the wireless device 10.

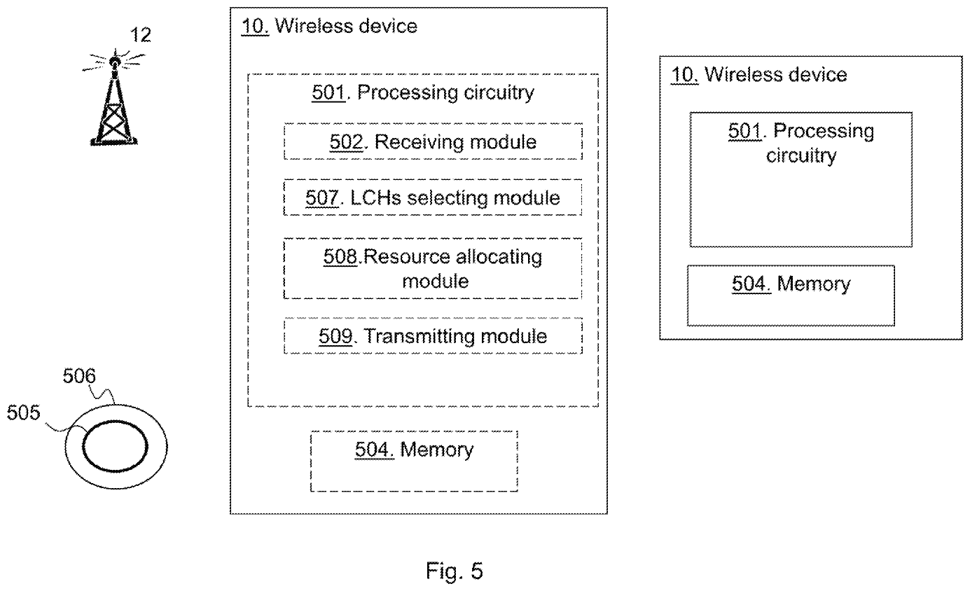

FIG. 5 is a block diagram depicting the wireless device 10 for performing logical channel prioritization according to embodiments herein. FIG. 5 may also be referred to as a block diagram depicting the wireless device 10 for transmitting data on prioritized logical channels according to embodiments herein.

The wireless device 10 may comprise processing circuitry 501, e.g. one or more processors, configured to perform the methods herein.

The wireless device 10 may comprise a receiving module 502, e.g. a receiver or transceiver. The radio network node 12, the processing circuitry 501 and/or the receiving module 502 may be configured to receive, e.g., from the radio network node 12, the LCP mapping restriction, e.g., via a RRC signalling. The wireless device 10, the processing circuitry 501 and/or the receiving module 502 may be further configured to receive, e.g., from the radio network node 12, the UL grant.

The wireless device 10 may also comprise the PHY entity (not shown) and the MAC entity (not shown) configured to perform the above corresponding actions. For instance, the physical (PHY) entity may send the LCP mapping restriction to the MAC entity.

The wireless device 10 may comprise an LCHs selecting module 507. The wireless device 10, the processing circuitry 501, the LCHs selecting module 507 and/or the MAC entity may be configured to select logical channels for the UL grant that satisfy the LCP mapping restriction.

In other words, the wireless device 10, e.g. by means of the LCHs selecting module 507 and/or the MAC entity, may be configured to select logical channels for the UL grant that satisfy the LCP mapping restriction. Thereby, the wireless device 10 may be configured to prioritize logical channels for the UL grant that satisfy the LCP mapping restriction. Thus, the wireless device 10, e.g. by means of the LCHs selecting module 507 and/or the MAC entity, may be configured to perform the LCP based on the received LCP mapping restriction.

As previously mentioned, the LCP mapping restriction comprises at least one out of: a transmission reliability requirement, a power control requirement, and information specifying whether a service's LCH is allowed to use the UL grant associated with a different service.

As also previously mentioned, the transmission reliability requirement may specify a maximum block error rate. Further, and as also previously mentioned, the power control requirement may specify at least one out of: a set of allowed P0-PUSCH-AlphaSet for transmission, and a set of allowed PUSCH closed loop index.

The wireless device 10 may comprise a resource allocating module 508. The wireless device 10, the processing circuitry 501, the resource allocating module 508 and/or the MAC entity may be configured to allocate resources to the selected LCHs according to the priorities of the selected LCHs. For instance, the resources are allocated in a decreasing priority order.

The wireless device 10 may comprise a transmitting module 509, e.g. a transmitter or transceiver. The wireless device 10, the processing circuitry 501 and/or the transmitting module 509 may be configured to transmit data using the allocated resources, e.g., to the radio network node 12.

The wireless device 10 further comprises a memory 504. The memory comprises one or more units to be used to store data on, such as UL grants, data, the LCP mapping restriction and/or the priorities of LCHs to perform the methods disclosed herein when being executed, and similar. Thus, the wireless device 10 may comprise the processing circuitry and the memory, said memory comprising instructions executable by said processing circuitry whereby said wireless device 10 is operative to perform the methods herein.

The methods according to the embodiments described herein for the wireless device 10 are respectively implemented by means of e.g. a computer program 505 or a computer program product 505, comprising instructions, i.e., software code portions, which, when executed on at least one processor, cause the at least one processor to carry out the actions described herein, as performed by the wireless device 10. The computer program product 505 may be stored on a computer-readable storage medium 506, e.g. a disc, USB or similar. The computer-readable storage medium 506, having stored thereon the computer program product 505, may comprise the instructions which, when executed on at least one processor, cause the at least one processor to carry out the actions described herein, as performed by the wireless device 10. In some embodiments, the computer-readable storage medium may be a non-transitory computer-readable storage medium.

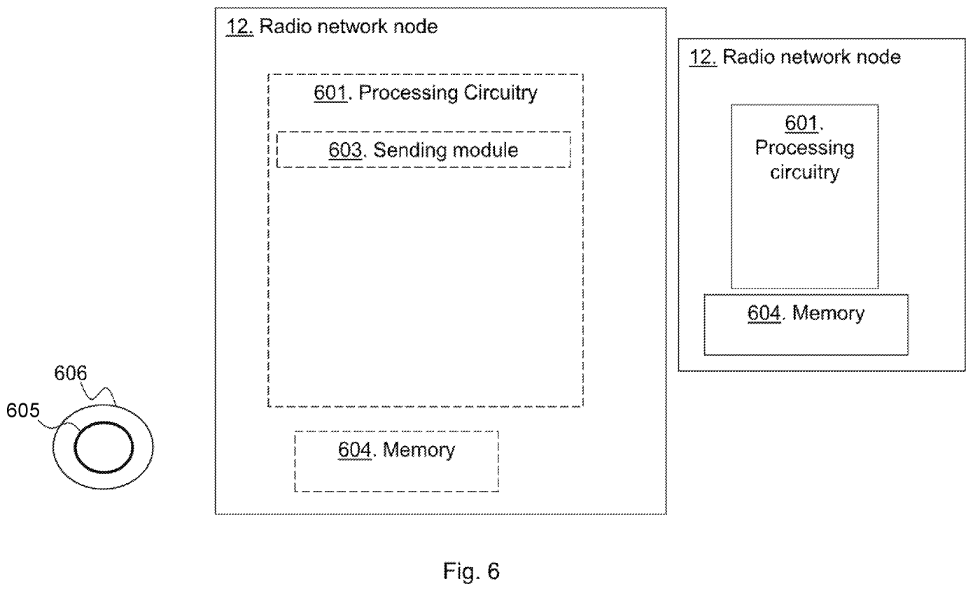

FIG. 6 is a block diagram depicting the radio network node 12 for facilitating a wireless device 10 performing logical channel prioritization according to embodiments herein. FIG. 6 may also be referred to as a block diagram depicting the radio network node 12 for facilitating the wireless device 10 in transmitting data on prioritized logical channels according to embodiments herein.

The radio network node 12 such as a radio base station may comprise processing circuitry 601, e.g. one or more processors, configured to perform the methods herein.

The radio network node 12 may comprise a sending module 603, e.g. a transmitter or a transceiver. The radio network node 12, the processing circuitry 601 and/or the transmitting module 603 may further configured to send, e.g., using a RRC signalling, the above LCP mapping restriction to the wireless device 10, for facilitating the wireless device 10 to select LCHs for the UL grant. The radio network node 12, the processing circuitry 601 and/or the transmitting module 603 may be configured to send the UL grant, e.g., associated to a service, to the wireless device 10.

As previously mentioned, the LCP mapping restriction comprises at least one out of: a transmission reliability requirement, a power control requirement, and information specifying whether a service's LCH is allowed to use the UL grant associated with a different service.

As also previously mentioned, the transmission reliability requirement may specify a maximum block error rate. Further, and as also previously mentioned, the power control requirement may specify at least one out of: a set of allowed P0-PUSCH-AlphaSet for transmission, and a set of allowed PUSCH closed loop index.

The radio network node 12 further comprises a memory 604. The memory comprises one or more units to be used to store data on, such as UL grants, data, the LCP mapping restriction, and/or the priorities of LCHs to perform the methods disclosed herein when being executed, and similar. Thus, the radio network node 12 may comprise the processing circuitry and the memory, said memory comprising instructions executable by said processing circuitry whereby said radio network node is operative to perform the methods herein.

The methods according to the embodiments described herein for the radio network node 12 are respectively implemented by means of e.g. a computer program 605 or a computer program product 605, comprising instructions, i.e., software code portions, which, when executed on at least one processor, cause the at least one processor to carry out the actions described herein, as performed by the radio network node 12. The computer program product 605 may be stored on a computer-readable storage medium 606, e.g. a disc or similar. The computer-readable storage medium 606, having stored thereon the computer program product 605, may comprise the instructions which, when executed on at least one processor, cause the at least one processor to carry out the actions described herein, as performed by the radio network node 12. In some embodiments, the computer-readable storage medium may be a non-transitory computer-readable storage medium.

As will be readily understood by those familiar with communications design, functions means or modules may be implemented using digital logic and/or one or more microcontrollers, microprocessors, or other digital hardware. In some embodiments, several or all of the various functions may be implemented together, such as in a single Application-Specific Integrated Circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, Digital Signal Processor (DSP) hardware, Read-Only Memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

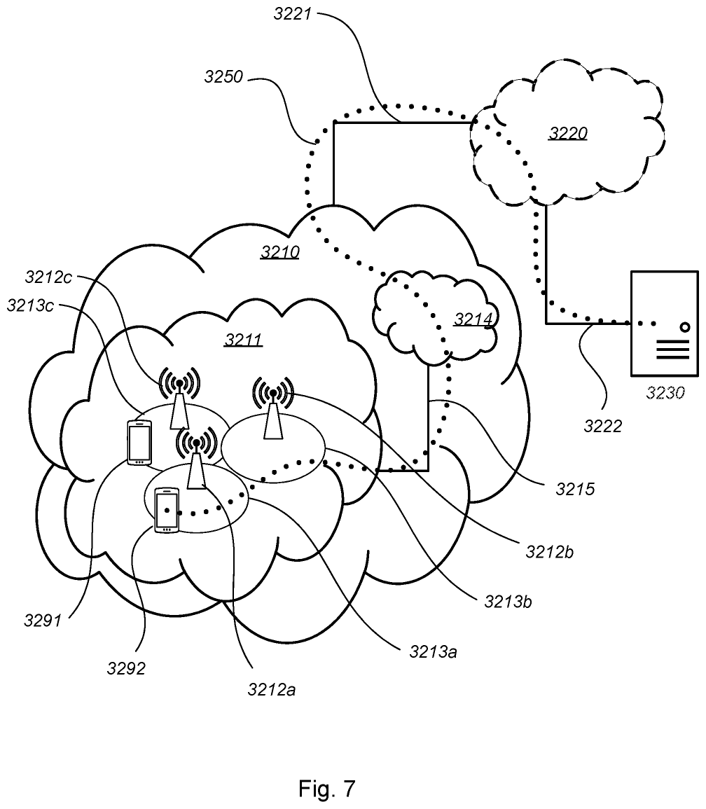

With reference to FIG. 7, in accordance with an embodiment, a communication system includes a telecommunication network 3210, e.g. the wireless communication network 1, such as a 3GPP-type cellular network, which comprises an access network 3211, e.g. the RAN1, such as a radio access network, and a core network 3214, e.g. the CN in FIG. 1. The access network 3211 comprises a plurality of base stations 3212a, 3212b, 3212c, e.g. the radio network node 12, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the wireless device 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

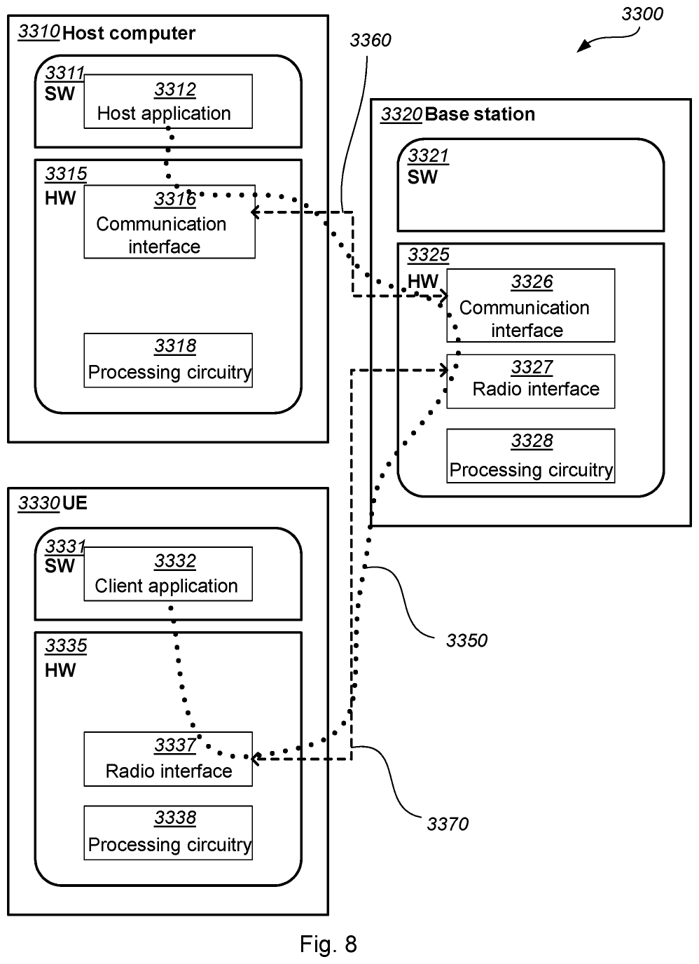

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in 10 which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve transmissions as number of transitions between states may be reduced and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

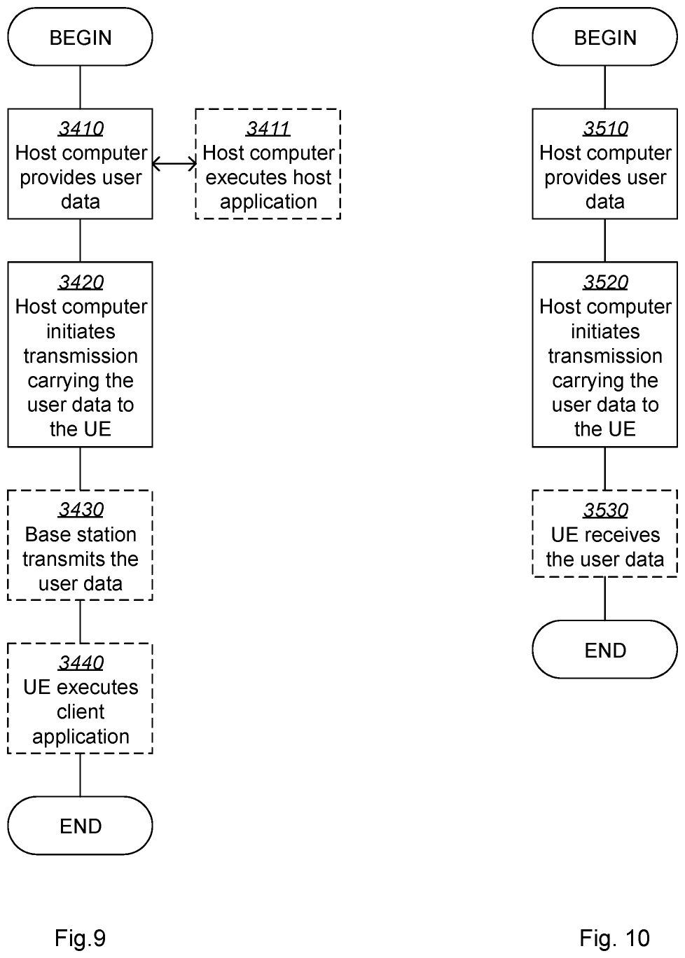

FIG. 9 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

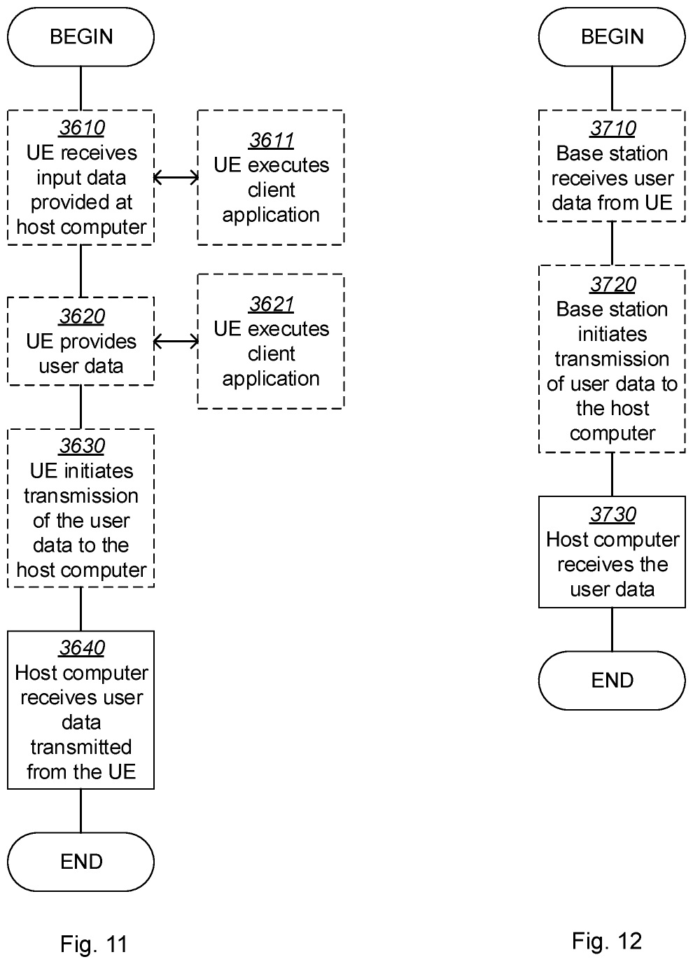

FIG. 11 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIG. 7 and FIG. 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

### Numbered Example Embodiments

US1. A wireless device for transmitting data on prioritized logical channels, 20 wherein the wireless device comprises a processor and a memory, said memory containing instructions executable by said processor whereby the wireless device is operative to:
receive a Logical Channel Prioritization, LCP, mapping restriction from a radio network node;
select logical channels, LCHs, for an uplink, UL, grant that satisfy the LCP mapping restriction; wherein the LCP mapping restriction comprises at least one out of: a transmission reliability requirement, a power control requirement, and information specifying whether a service's LCH is allowed to use the UL grant associated with a different service;
allocate resources to the selected LCHs according to priorities of the selected LCHs; and
transmit data using the allocated resources.

US2. The wireless device of US1, further being operative to:
send, by a physical, PHY, entity of the wireless device, the LCP mapping restriction to a Medium Access Control, MAC, entity of the wireless device; and
by means of the MAC entity, performing LCP based on the received LCP mapping restriction.

US3. The wireless device of US1 or US2, wherein the transmission reliability requirement specifying specifies a maximum block error rate.

US4. The wireless device of any one of US1-US3, wherein the power control requirement specifies at least one out of: a set of allowed P0-PUSCH-AlphaSet for transmission, and a set of allowed PUSCH closed loop index.

US5. A radio network node for facilitating a wireless device in transmitting data on prioritized logical channels, wherein the radio network node comprises a processor and a memory, said memory containing instructions executable by said processor whereby the radio network node is operative to:
send a Logical Channel Prioritization, LCP, mapping restriction to the wireless device for facilitating the wireless device selecting logical channels, LCHs, for an uplink, UL, grant, wherein the LCP mapping restriction comprises at least one out of: a transmission reliability requirement, a power control requirement, and information specifying whether a service's LCH is allowed to use the UL grant associated with a different service.

US6. The radio network node of US5, wherein the transmission reliability requirement specifies a maximum block error rate.

US7. The radio network node of US5 or US6, the power control requirement specifying at least one out of: a set of allowed P0-PUSCH-AlphaSet for transmission, and a set of allowed PUSCH closed loop index.

CN1. A wireless device (10) for transmitting data on prioritized logical channels, the wireless device (10) comprises:
a receiving module (502) configured to receive a Logical Channel Prioritization, LCP, mapping restriction from a radio network node (12);
a selecting module (507) configured to select logical channels, LCHs, for an uplink, UL, grant that satisfy the LCP mapping restriction; wherein the LCP mapping restriction comprises at least one out of: a transmission reliability requirement, a power control requirement, and information specifying whether a service's LCH is allowed to use the UL grant associated with a different service;
a resource allocating module (508) configured to allocate resources to the selected LCHs according to priorities of the selected LCHs; and
a transmitting module (509) configured to transmit data using the allocated resources.

CN2. The wireless device (10) of CN1, further comprising:
a physical, PHY, configured to send the LCP mapping restriction to a Medium Access Control, MAC, entity of the wireless device (10), and wherein
the MAC entity is configured to perform LCP based on the received LCP mapping restriction.

CN3. The wireless device (10) according to CN1 or CN2, wherein the transmission reliability requirement specifies a maximum block error rate.

CN4. The wireless device (10) according to any of the CN1CN4, wherein the power control requirement is configured to specify at least one out of: a set of allowed P0-PUSCH-AlphaSet for transmission, and a set of allowed PUSCH closed loop index.

CN5. A radio network node (12) for facilitating a wireless device (10) in transmitting data on prioritized logical channels, wherein the radio network node (12) comprises:
a sending module (603) configured to send a Logical Channel Prioritization, LCP, mapping restriction to the wireless device (10) for facilitating the wireless device (10) in selecting logical channels, LCHs, for an uplink, UL, grant, wherein the LCP mapping restriction comprises at least one out of: a transmission reliability requirement, a power control requirement, and information specifying whether a service's LCH is allowed to use the UL grant associated with a different service.

CN6. The radio network node (12) according to CNS, wherein the transmission reliability requirement specifies a maximum block error rate.

CN7. The radio network node (12) according to CN6 or CN6, wherein the power control requirement specifies at least one out of: a set of allowed P0-PUSCH-AlphaSet for transmission, and a set of allowed PUSCH closed loop index.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a wireless device, for transmitting data on logical channels, wherein the method comprises:
receiving a Logical Channel Prioritization, LCP, mapping restriction from a radio network node;
selecting logical channels, LCHs, for an uplink, UL, grant that satisfy the LCP mapping restriction; wherein the LCP mapping restriction comprises at least one out of: a transmission reliability requirement, a power control requirement, and information specifying whether a service's LCH is allowed to use the UL grant associated with a different service;
allocating resources to the selected LCHs according to priorities of the selected LCHs; and
transmitting data using the allocated resources.

2. The method according to claim 1, further comprising:
sending, by a physical, PHY, entity of the wireless device, the LCP mapping restriction to a Medium Access Control, MAC, entity of the wireless device; and
by means of the MAC entity, performing LCP based on the received LCP mapping restriction.

3. The method according to claim 1, wherein the transmission reliability requirement specifies a maximum block error rate.

4. The method according to claim 1, wherein the power control requirement specifies at least one out of: a set of allowed P0-PUSCH-AlphaSet for transmission, and a set of allowed PUSCH closed loop index.

5. A method performed by a radio network node for facilitating a wireless device in transmitting data on prioritized logical channels, wherein the method comprises:
sending a Logical Channel Prioritization, LCP, mapping restriction to the wireless device for facilitating the wireless device selecting logical channels, LCHs, for an uplink, UL, grant, wherein the LCP mapping restriction comprises at least one out of: a transmission reliability requirement, a power control requirement, and information specifying whether a service's LCH is allowed to use the UL grant associated with a different service.

6. The method according to claim 5, wherein the transmission reliability requirement specifies a maximum block error rate.

7. The method according to claim 5, the power control requirement specifying at least one out of: a set of allowed P0-PUSCH-AlphaSet for transmission, and a set of allowed PUSCH closed loop index.

8. A wireless device for transmitting data on prioritized logical channels, the wireless device comprising processing circuitry configured to:
receive a Logical Channel Prioritization, LCP, mapping restriction from a radio network node;
select logical channels, LCHs, for an uplink, UL, grant that satisfy the LCP mapping restriction; wherein the LCP mapping restriction comprises at least one out of: a transmission reliability requirement, a power control requirement, and information specifying whether a service's LCH is allowed to use the UL grant associated with a different service;
allocate resources to the selected LCHs according to priorities of the selected LCHs; and
transmit data using the allocated resources.

9. The wireless device according to claim 8, wherein the wireless device is further configured to:
send, by a physical, PHY, entity of the wireless device, the LCP mapping restriction to a Medium Access Control, MAC, entity of the wireless device, and
perform, by means of the MAC entity, LCP based on the received LCP mapping restriction.

10. The wireless device according to claim 8, wherein the transmission reliability requirement specifies a maximum block error rate.

11. The wireless device according to any of the claims claim 8, wherein the power control requirement specifying at least one out of: a set of allowed P0-PUSCH-AlphaSet for transmission, and a set of allowed PUSCH closed loop index.

12. A radio network node for facilitating a wireless device in transmitting data on prioritized logical channels, wherein the radio network node comprising processing circuitry configured to:
send a Logical Channel Prioritization, LCP, mapping restriction to the wireless device for facilitating the wireless device in selecting logical channels, LCHs, for an uplink, UL, grant, wherein the LCP mapping restriction comprises at least one out of: a transmission reliability requirement, a power control requirement, and information specifying whether a service's LCH is allowed to use the UL grant associated with a different service.

13. The radio network node according to claim 12, wherein the transmission reliability requirement specifies a maximum block error rate.

14. The radio network node according to claim 12, wherein the power control requirement specifying at least one out of: a set of allowed P0-PUSCH-AlphaSet for transmission, and a set of allowed PUSCH closed loop index.

15. A computer program product comprising instructions, which, when executed on at least one processor, cause the at least one processor to carry the method according to claim 1, as performed by the wireless device.

16. A computer-readable storage medium, having stored thereon a computer program product comprising instructions which, when executed on at least one processor, cause the at least one processor to carry out the method according to claim 1, as performed by the wireless device.

17-18. (canceled)

19. A computer program product comprising instructions, which, when executed on at least one processor, cause the at least one processor to carry the method according to claim 5, as performed by the radio network node.

20. A non-transitory computer-readable storage medium, having stored thereon a computer program product comprising instructions which, when executed on at least one processor, cause the at least one processor to carry out the method according to claim 5, as performed by the radio network node.
